(19) United States
(12) Patent Application Publication
(10) Pub. No.: US 2022/0095446 A1
(43) Pub. Date: Mar. 24, 2022

(54) ENGINEERED STRUCTURES THAT FLY IN PLANETARY ATMOSPHERES VIA THE PHOTOPHORETIC FORCE

(71) Applicant: Angela J Feldhaus, Somerville, MA (US)

(72) Inventor: Angela J Feldhaus, Somerville, MA (US)

(21) Appl. No.: 17/447,957

(22) Filed: Sep. 17, 2021

Related U.S. Application Data
(60) Provisional application No. 63/081,816, filed on Sep. 22, 2020.

(51) Int. Cl. H05H 3/02

(52) U.S. Cl. CPC H05H 3/02

(57) ABSTRACT

The present invention comprises a device designed to fly in planetary atmospheres via the photophoretic force. The photophoretic force may result from the phenomena of ΔT photophoresis, Δα photophoresis, and/or thermal creep flow. Certain embodiments of the structure may control flight by changing the direction of the net photophoretic force through structural elements that impart magnetic, electric, or gravitational torques on the entire structure. Payloads with many conceivable uses may be integrated into this invention. Examples of use include but are not limited to wireless data communications, optical devices, microelectronics, and remote sensing technologies.

### FIELD OF THE INVENTION

The present invention relates to engineered structures that fly in planetary atmospheres by the photophoretic force. The design of the invention can be modified to achieve flight at different pressures and/or altitudes for various amounts of time. The invention is designed to carry payloads for various applications. Related fields to this invention include but are not limited to wireless data communications, optical devices, microelectronics, and remote sensing technologies.

### BACKGROUND OF THE INVENTION

The theory of photophoresis explains the levitation of aerosols in Earth's atmosphere at certain altitudes. These aerosols typically have microscale particle diameters and are liquid, though solid aerosols have been shown to levitate as well. (Cheremisin et al., 2005; Rohatschek, 1996)

Photophoretic forces on aerosols in the atmosphere result from solar insolation on the aerosol and from the aerosol's size relative to the mean free path of surrounding gas molecules. Radiative and thermal properties of the aerosol affect the strength of the forces. Strong enough forces will stably levitate the aerosols at certain altitudes in the atmosphere. Replication of the levitation of aerosols has been achieved in a laboratory setting, as has levitation of fabricated structures with tuned thermal and radiative parameters. (Azadi et al., 2020; Cortes et al., 2020) Theoretical use of such structures in Earth's atmosphere has also been examined. (Keith, 2010) There have been other laboratory utilizations of the photophoretic force, such as the Optical Trap Display for displays, (Smalley et al., 2018) that have thus far been limited to on-engineered particles solely in laboratory settings.

The field of aeronautics is constantly striving to decrease the cost of producing and operating air and spacecraft. Traditional craft are generally limited by the need for power systems such as fuel or solar power to remain in flight for useful amounts of time. There are currently few sustainable low cost options for applications in, for instance, data communications and remote sensing.

There is a clear need for structures that are capable of lifting and moving payloads of multiple times their own weight and at little cost. There is a need for precision control of the location of in-flight structures with a broad range of applications. Engineered devices that utilize the photophoretic force for flight propulsion would be able to operate at lower costs for longer time periods, in some cases indefinitely, without carrying conventional power sources. Dramatically lower operational and production costs coupled with long flight times enable a variety of currently unavailable device capabilities. The micron to millimeter scales of certain embodiments of these devices allow for unobtrusive atmospheric placement that would not disrupt aircraft or sightlines. Conceivable applications of this invention on other planets include wireless communication networks or terraforming agents.

### BRIEF SUMMARY OF THE INVENTION

Unless specifically stated or obvious from context, as used herein, the terms “flight,” “fly,” “flies,” and “flying” are understood to mean directed motion, undirected motion, or levitation within a gaseous planetary atmosphere. These terms also encompass actions including but not limited to transporting, lofting, hovering, suspending, floating, gliding, falling, and settling. Gaseous planetary atmospheres include the atmosphere of Earth from sea level through the thermosphere and the atmospheres of other planets in similar pressure regimes.

The present invention comprises any engineered structure that flies in planetary atmospheres by the photophoretic force induced from radiative forcing. These structures can be a variety of designs and the photophoretic force can arise through three mechanisms. The first mechanism is a nonzero temperature gradient among different sides or surfaces of the structure, known in scientific literature as “ΔT photophoresis,” where 66 T is the difference in temperature between the surfaces of interest and the ambient gas. The second mechanism is an inhomogeneity in accommodation coefficients among different sides or surfaces of the structure, known in scientific literature as “Δα photophoresis,” where Δα is the difference in accommodation coefficients between two surfaces of interest. The third mechanism is thermal creep flow through and/or around the structure that produces thrust on and/or levitation of the structure. Examples of radiative forcing include but are not limited to natural sources such as solar radiation and planetary thermal upwelling and manmade sources such as ground or aircraft-based lasers.

Unless specifically stated or obvious from context, as used herein, the term “payload” is understood to mean any part or substructure of the invention with purpose separate to sourcing the photophoretic force, though this may still be a purpose. Examples of payloads include but are not limited to: substructures intended to orient the present invention via an aligning torque, substructures intended to alter the optical properties of the invention so as to alter the photophoretic force on all or part of the invention, films or coatings intended to protect the invention from degradation due to gas-phase chemistry or exposure to ultraviolet light, substructures intended to alter the thermal creep flow through or around the invention (such as micro-electromechanical systems that selectively block one or more channels within the main structure), substructures for receiving and/or transmitting data in the form of electromagnetic radiation, computers, processors, integrated circuits, sensors, optical equipment, reflectors, power systems, photovoltaics, and material or substructures for deployment.

The dimensions and mass of the present invention are confined by the ambient pressure, radiative forcing, and temperature of the environment of use. In certain embodiments, the structure may range from tens of nanometers to tens of millimeters in width and length and range from tens of nanometers to tens of micrometers in height. One preferred embodiment has thickness on the order of hundreds of nanometers and is comprised of a series of one or more thin films of material. Another preferred embodiment has thickness on the order of tens of micrometers, but is largely hollow with channels connecting the top and bottom surfaces, with length and width on the order of millimeters or centimeters.

### BRIEF DESCRIPTION OF THE DRAWINGS

FIG. 1 depicts a side perspective view of one example of a structure with uniform temperature that flies solely by Δα photophoresis.

FIG. 2 illustrates the mechanism by which Δα photophoresis allows flight of a structure that has a higher accommodation coefficient α on the bottom surface than the top.

FIG. 3 depicts a side perspective view of one example of a structure that contains a temperature difference between the top and bottom surfaces, so as to induce ΔT photophoresis.

FIG. 4 illustrates the mechanism by which ΔT photophoresis flies a structure that has a higher temperature on the bottom surface than the top.

FIG. 5 depicts a side perspective view of one example of a structure that contains a temperature difference between the top and bottom surfaces and channels that allow for thermal creep flow through the structure.

FIG. 6 illustrates the mechanism by which thermal creep flow lofts a structure that has a higher temperature on the bottom surface than the top.

FIG. 7 depicts two possible ways to align a photophoretically lofting structure so that the lofting force points towards the solar zenith. It is also a side perspective view of one embodiment of the invention that is lofting a payload.

FIG. 8 depicts a bottom view of a possible embodiment of the structure shown in FIG. 7 where the shape of the structure is a thin plate.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Engineered structures that fly via the photophoretic force are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

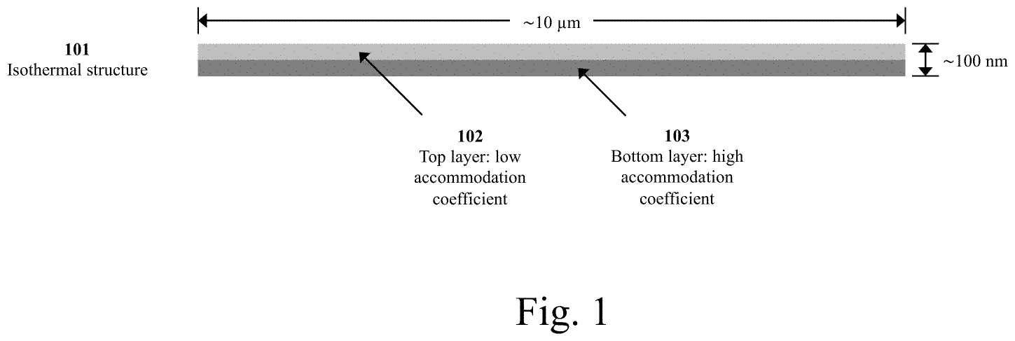

The present invention will now be described by referencing the appended figures representing preferred embodiments. FIG. 1 depicts a side perspective view of an example of a certain embodiment of the invention, where the thin structure of uniform temperature 101 flies in Earth's atmosphere solely via Δα photophoresis. In this embodiment, the total structure has horizontal dimensions on the order of 10 microns and a total thickness on the order of 100 nanometers. The top layer 102 has a lower accommodation coefficient a than the bottom layer 103. In certain embodiments, the invention may comprise one or more layers. In this and other embodiments, these layers may be made of metals, metal oxides, glasses, degradation-resistant plastics, or other suitable materials. They may be fabricated using various nanofabrication techniques, such as atomic layer deposition, chemical vapor deposition, and spin coating. In certain preferred embodiments, the masses of these layers are minimized so as to maximize the ratio of the photophoretic force on the invention to the gravitational force on the invention. In certain preferred embodiments, the optical properties of 102 and 103 are chosen to optimize the temperature difference between the structure 101 and the ambient gas at different atmospheric altitudes.

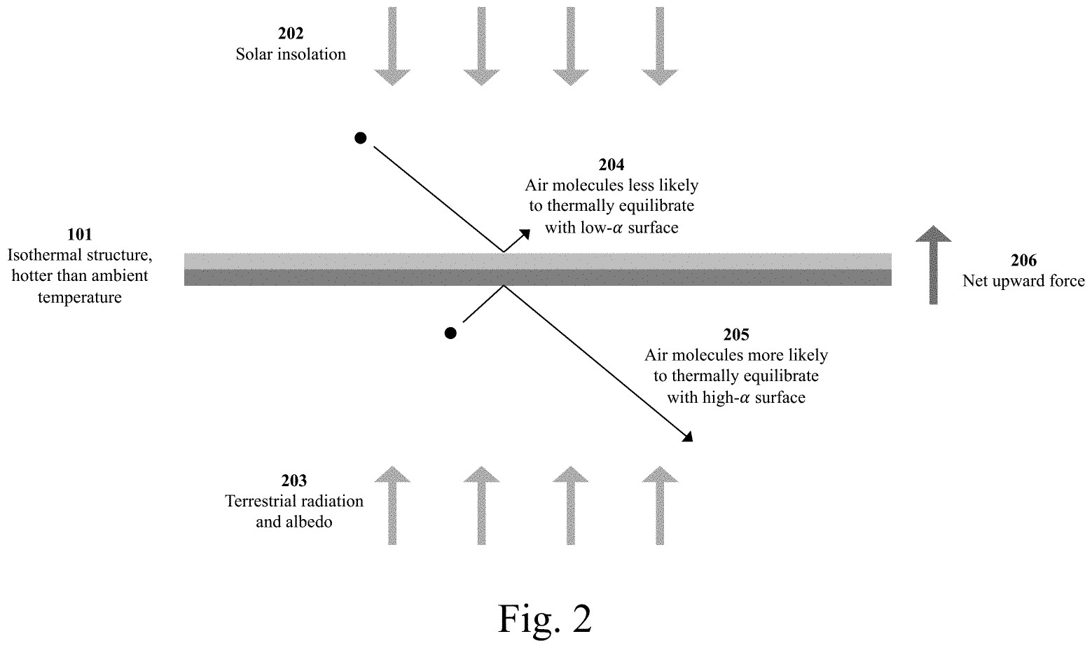

FIG. 2 illustrates the mechanism by which the embodiment in FIG. 1 flies. Thin isothermal structure 101 becomes hotter than the surrounding ambient gas by receiving radiative forcing from solar insolation 202 from above and terrestrial radiation and albedo 203 from below. Gas molecules 204 are less likely to thermally equilibrate with the structure 101 upon collision with the top surface than gas molecules 205 are upon collision with the bottom surface. This results in a net upward force 206 on the structure.

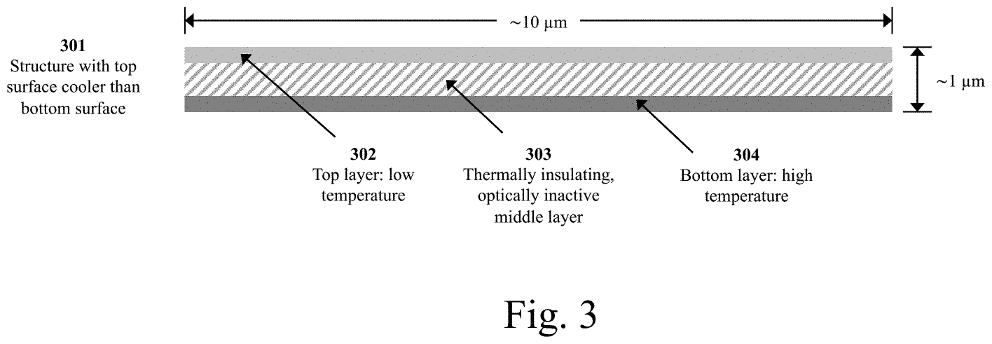

FIG. 3 depicts a side perspective view of an example of a certain embodiment of the invention, where the shown structure 301 contains a temperature gradient between top and bottom layers 302 and 304, respectively. In this embodiment, the total structure has horizontal dimensions on the order of 10 microns and a total thickness on the order of 1 micron. The top layer 302 is cooler than the bottom layer 304. The temperature gradient is maintained by a thermally insulating middle layer 303. In certain preferred embodiments, the optical properties of 302 and 304 and the thermal properties of 303 are chosen to optimize the temperature difference between the surfaces at different atmospheric altitudes. In certain embodiments, the thermal insulation 303 may simply be ambient gas such that the structure 301 is hollow and structural supports between the top and bottom layers are installed.

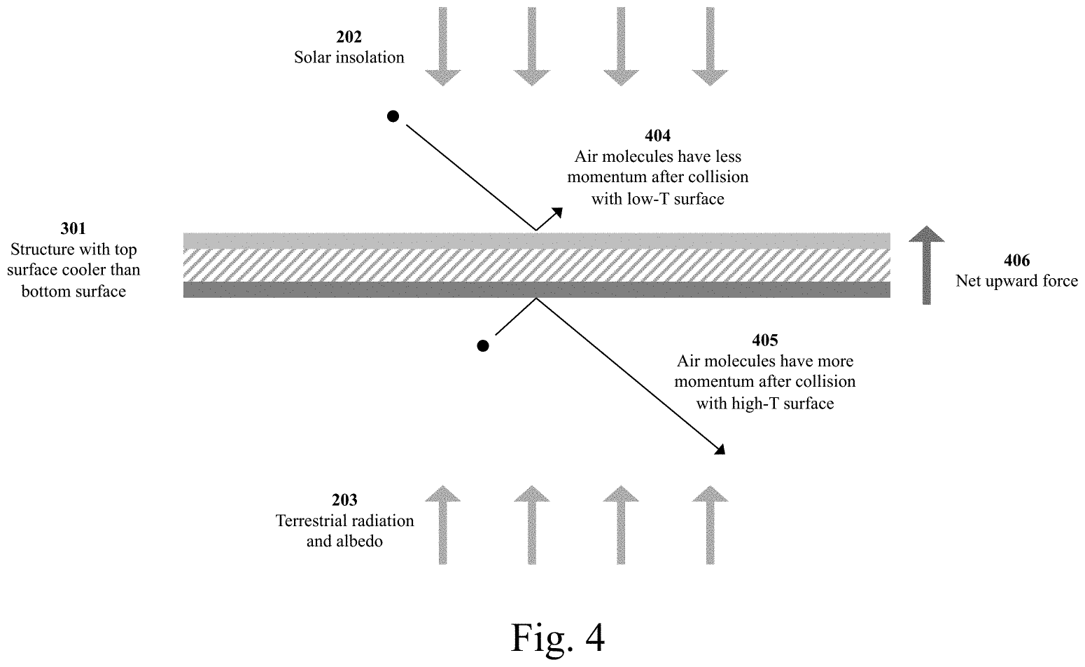

FIG. 4 illustrates the mechanism by which the embodiment in FIG. 3 flies. The structure 301 has its top surface become cooler than the bottom structure by receiving radiative forcing from solar insolation 202 from above and terrestrial radiation and albedo 203 from below. Gas molecules 404 have less momentum upon collision with the top surface than gas molecules 205 have upon collision with the bottom surface. This results in a net upward force 406 on the structure.

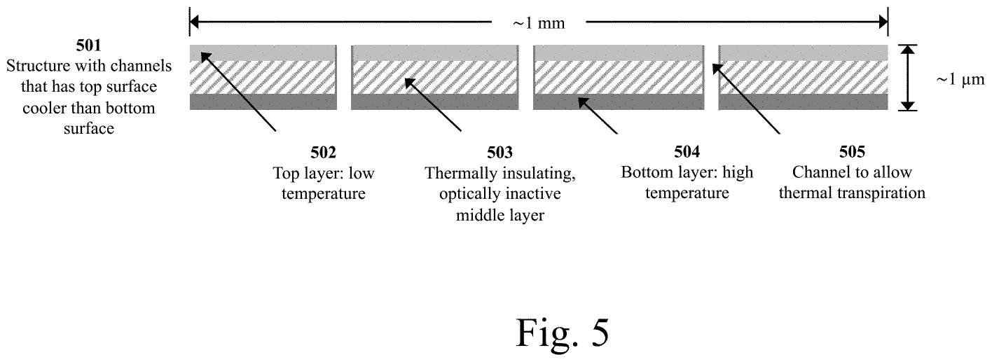

FIG. 5 depicts a side perspective view of an example of a certain embodiment of the invention, where the shown structure 501 contains a temperature gradient between top and bottom layers 502 and 504, respectively, and one or more channels 505 spaced throughout the entire structure. In this embodiment, the total structure has horizontal dimensions on the order of 1 millimeter (mm) and a total thickness on the order of 1 micron. The top layer 502 is cooler than the bottom layer 504. The temperature gradient is maintained by a thermally insulating middle layer 503. In certain preferred embodiments, the optical properties of 502 and 504 and the thermal properties of 503 and the material comprising the channel(s) 505 are chosen to optimize the temperature difference between the surfaces at different atmospheric altitudes. In certain preferred embodiments, the channels are spaced regularly, such as in the basket-weave patterns described in U.S. Patent No. 20190070824A1. (Bargatin et al., 2019)

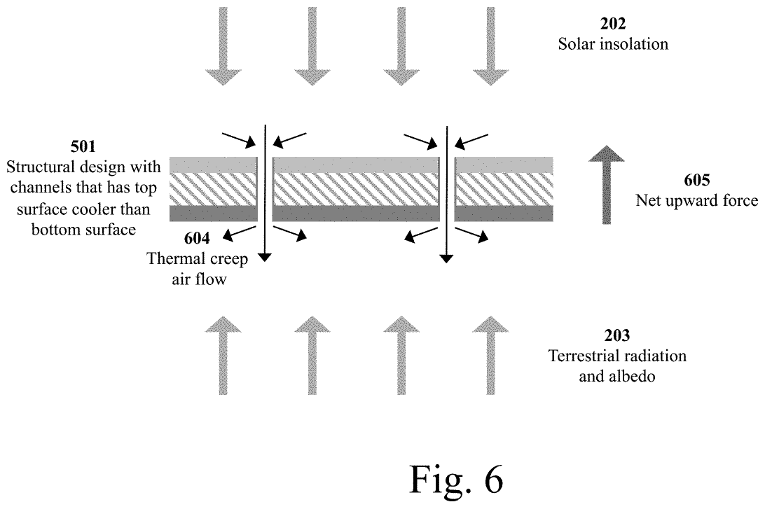

FIG. 6 illustrates the mechanism by which the embodiment in FIG. 5 flies. The structure 501 has its top surface become cooler than the bottom structure by receiving radiative forcing from solar insolation 202 from above and terrestrial radiation and albedo 203 from below. In the free molecular flow regime, air 604 will flow through the channels from the cool top surface towards the hot bottom surface by means of thermal creep. This creates an upward thrusting force 605 on the structure. In certain preferred embodiments, the invention flies by a combination of the mechanisms described in FIGS. 2, 4, and 6.

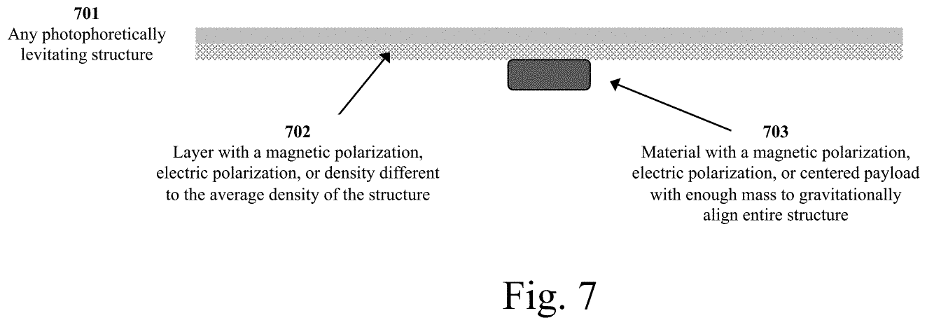

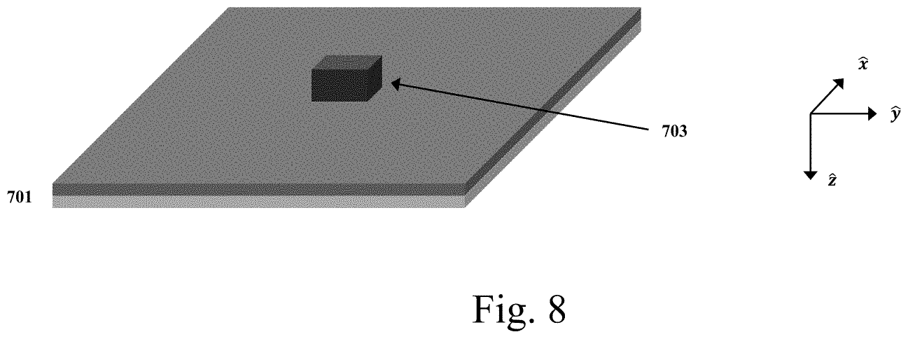

FIG. 7 depicts a side perspective view of an example of a certain preferred embodiment of the invention and FIG. 8 depicts a bottom view of this embodiment with the main structure in the shape of a thin plate. Any photophoretically active flying structure 701 can be aligned to Earth's gravitational, electric, or magnetic fields by containing a substructure that lends the total structure a gravitational, electric, or magnetic torque in the atmosphere. A layer with a magnetic polarization, electric polarization, or density different to the average density of the structure 702 can be used for this purpose. Magnetic and/or electric polarizations can alternatively be embodied in a payload 703 separate from the main structure 701. A gravitational torque could also be produced by a payload 703 that the structure 701 is designed to loft into the atmosphere. The payload 703 might be attached to the main structure 701 by means of adhesive, magnetic attraction, chemical bonding, or other feasible techniques.

### CITATIONS

Azadi, M., Popov, G. A., Lu, Z., Eskenazi, A. G., Bang, J. W., Campbell, M. F., Hu, H., Bargatin, I., 2020. Controlled photophoretic levitation of nanostructured thin films for near-space flight. ArXiv200506493 Phys.
Bargatin, I., Lin, C., Nicaise, S., 2019. Ultrathin hollow plates and their applications. US20190070824A1.
Cheremisin, A. A., Vassilyev, Yu. V., Horvath, H., 2005. Gravito-photophoresis and aerosol stratification in the atmosphere. J. Aerosol Sci. 36, 1277-1299.
Cortes, J., Stanczak, C., Azadi, M., Narula, M., Nicaise, S. M., Hu, H., Bargatin, I., 2020. Photophoretic Levitation of Macroscopic Nanocardboard Plates. Adv. Mater. n/a, 1906878.
Keith, D. W., 2010. Photophoretic levitation of engineered aerosols for geoengineering. Proc. Natl. Acad. Sci. 107, 16428-16431.
Rohatschek, H., 1996. Levitation of stratospheric and mesospheric aerosols by gravito-photophoresis. J. Aerosol Sci. 27, 467-475.
Smalley, D. E., Nygaard, E., Squire, K., Van Wagoner, J., Rasmussen, J., Gneiting, S., Qaderi, K., Goodsell, J., Rogers, W., Lindsey, M., Costner, K., Monk, A., Pearson, M., Haymore, B., Peatross, J., 2018. A photophoretic-trap volumetric display. Nature 553, 486-490.

What is claimed is:

1. An engineered structure that is designed to fly in the atmosphere via the photophoretic force.

2. The structure of claim 1, wherein flying is achieved via a temperature gradient within the structure.

3. The structure of claim 1, wherein flying is achieved via a nonuniformity of the thermal and/or momentum accommodation coefficients along the external surface of the structure.

4. The structure of claim 1, wherein flying is achieved via thrust produced by thermal creep flow through or around the structure.

5. The structure of claim 1, wherein flying is achieved via any combination of the mechanisms described in claims 2, 3, and 4.

6. The structure of claim 5, wherein a payload with purposes separate to but not necessarily excluding sourcing the photophoretic force is integrated within and/or connected to the structure.

7. The structure of claim 5, wherein a gravitational torque inherent to the structure acts to align it with the surrounding gravitational field.

8. The structure of claim 5, wherein magnetically and/or electrically polarized components of the structure act to align it with surrounding magnetic and/or electric fields.

9. The structure of claim 5, wherein one or more elements of the structure have optical properties used for applications besides flight.

10. A fleet of two or more structures described by claim 5 where the structures operate independently and/or dependently of each other and/or communicate with each other.
